(19) United States
(12) Patent Application Publication
(10) Pub. No.: US 2013/0026933 A1
(43) Pub. Date: Jan. 31, 2013

(54) LED BACKLIGHT DRIVE CIRCUIT

(71) Applicant: Xinming Gao, Shenzhen (CN)

(72) Inventor: Xinming Gao, Shenzhen (CN)

(73) Assignee: Shenzhen China Star Optoelectronics Technology Co., Ltd., Shenzhen (CN)

(21) Appl. No.: 13/380,039

(22) PCT Filed: Oct. 18, 2011
(86) PCT No.: PCT/CN11/80922

§ 371 Date: Dec. 22, 2011

(30) Foreign Application Priority Data
Jul. 25, 2011 (CN) 201120264443.3

(51) Int. Cl. H05B 37/02

(52) U.S. Cl. 315/192

(57) ABSTRACT

An LED backlight drive circuit comprises a plurality of LED lamp strings connected in parallel, a constant-current control circuit for controlling magnitudes of currents flowing through the LED lamp strings to be the same, and a plurality of constant-voltage units. The number of the constant-voltage units is the same as that of the LED lamp strings. The constant-voltage units are connected between the LED lamp strings and the constant-current control circuit respectively. Each constant-voltage units comprises an MOS transistor and a first operational amplifier. The MOS transistor has a drain connected to a cathode of a corresponding LED lamp strings, a gate connected to an output terminal of the first operational amplifier and a source connected to the constant-current control circuit. The first operational amplifier has a positive input terminal connected to a reference voltage and an inverting input terminal connected to the source of the MOS transistor.

### BACKGROUND

1. Technical Field

The present disclosure relates to the field of light emitting diode (LED) backlight driving, and more particularly, to an LED backlight drive circuit.

2. Description of Related Art

Owing to development of related technologies and driven by users' demands, liquid crystal panels are made to have increasingly larger sizes. In light emitting diode (LED) backlight drive circuits of prior art large-size liquid crystal panels, a constant-current control circuit 12 (e.g., a balance IC) must be used to control a plurality of LED strings simultaneously to accomplish accurate control of the LED current of each of the LED strings.

FIG. 1 is a schematic circuit diagram of an LED backlight drive circuit in a prior art large-size liquid crystal panel. As shown in FIG. 1, the LED backlight drive circuit comprises a voltage input terminal Vin, an inductor L1, a metal oxide semiconductor (MOS) transistor (MOSFET) Q1, a diode D1, a plurality of LED lamp strings 11, a constant-current control circuit 12 (e.g., a balance IC), a minimum voltage detection circuit 13, a pulse width modulation (PWM) control circuit 14 and an operational amplifier OP1. The inductor L1 is used to store and release electric energy in such a way that electric energy is stored in the inductor L1 when the MOS transistor Q1 is turned on and is released from the inductor L1 to the LED lamp strings 11 when the MOS transistor Q1 is turned off. Through quick turning on/off of the MOS transistor Q1, electric energy can be stored in and released from the inductor L1. The diode D1 is used to prevent introduction of the voltage from the anodes of the LED lamp strings 11 back into the inductor when the MOS transistor Q1 is turned on and to rectify the current when the MOS transistor Q1 is turned off. The constant-current control circuit 12 is configured to control magnitudes of currents flowing through the LED lamp strings 11 to be the same. The minimum voltage detection circuit 13 is configured to feed back a minimum voltage of cathodes of the LED lamp strings 11 to the operational amplifier OP1.

The operational amplifier OP1 has a positive input terminal for receiving a reference voltage V0 and an inverting input terminal for receiving the aforesaid minimum voltage. The operational amplifier OP1 is configured to adjust an output voltage according to the minimum voltage received at the inverting input terminal thereof. The PWM control circuit 14 is configured to adjust a duty ratio of a PWM signal according to the output voltage of the operational amplifier OP1 so that a turn-on time and a turn-off time of the MOS transistor Q1 can be adjusted to adjust the anode voltage of the LED lamp strings 11. Specifically, if the minimum voltage is lower than the reference voltage V0, the output voltage of the operational amplifier OP1 will increase; consequently, the duty ratio of the PWM signal outputted by the PWM control circuit 14 increases to result in an increased anode voltage of the LED lamp strings 11. Conversely, when the minimum voltage is higher than the reference voltage V0, the anode voltage of the LED lamp strings 11 will decrease.

The plurality of LED lamp strings 11 described above have a common anode voltage but the sum of turn-on voltage drops of the LEDs is different for each of the LED lamp strings 11, so the LED lamp strings 11 have different cathode voltages. The voltage differences among these voltages will be applied to the constant-current control circuit 12 (balance IC) to cause an increase in power loss and, consequently, a rise in temperature of the balance IC, which will compromise stability of the LED backlight drive circuit.

### BRIEF SUMMARY

The primary objective of the present disclosure is to provide an LED backlight drive circuit, which can solve the problems of large power loss and a high temperature rise of the circuit so as to improve stability of the circuit.

To achieve the aforesaid objective, the present disclosure provides an LED backlight drive circuit, which comprises a plurality of LED lamp strings connected in parallel, a constant-current control circuit for controlling magnitudes of currents flowing through the LED lamp strings to be the same and a plurality of constant-voltage units. The number of the constant-voltage units is equal to the number of the LED lamp strings. The plurality of constant-voltage units are connected between the plurality of LED lamp strings and the constant-current control circuit respectively. Each of the constant-voltage units comprises a metal oxide semiconductor (MOS) transistor and a first operational amplifier. The MOS transistor has a drain connected to a cathode of a corresponding one of the LED lamp strings, a gate connected to an output terminal of the first operational amplifier and a source connected to the constant-current control circuit. The first operational amplifier has a positive input terminal connected to a reference voltage and an inverting input terminal connected to the source of the MOS transistor.

Preferably, the reference voltage is 1 volt (V).

Preferably, the MOS transistor is an NMOS transistor.

Preferably, the constant-current control circuit is a balance chip.

Preferably, the LED backlight drive circuit further comprises a switch unit, an inductor and a rectification anti-backflow unit. One terminal of the inductor is used to receive an input voltage and the other terminal of the inductor is connected to anodes of the LED lamp strings via the rectification anti-backflow unit. The switch unit has a first terminal connected between the inductor and the rectification anti-backflow unit, a second terminal connected to the ground, and a control terminal for receiving a pulse width modulation (PWM) signal.

Preferably, the rectification anti-backflow unit is a diode which has an anode connected to the inductor and a cathode connected to the anodes of the LED lamp strings.

Preferably, the switch unit is an MOS transistor, which has a drain connected between the inductor and the rectification anti-backflow unit, a source connected to the ground, and a gate for receiving a PWM signal.

Preferably, the LED backlight drive circuit further comprises a minimum voltage detection circuit, a PWM control circuit for outputting the PWM signal and a second operational amplifier. An input terminal of the minimum voltage detection circuit is connected to the cathodes of the LED lamp strings. The second operational amplifier has an inverting input terminal connected to an output terminal of the minimum voltage detection circuit, a positive input terminal connected to another reference voltage, and an output terminal connected to the PWM control circuit. And the PWM control circuit is connected to the control terminal of the switch unit.

Preferably, the reference voltage connected to the positive input terminal of the second operational amplifier is 2.5 V.

The present disclosure further provides an LED backlight drive circuit, comprising a plurality of LED lamp strings connected in parallel and a constant-current control circuit for controlling magnitudes of currents flowing through the LED lamp strings to be the same, wherein the LED backlight drive circuit further comprises:

a plurality of constant-voltage units connected between the plurality of LED lamp strings and the constant-current control circuit respectively, wherein the number of the constant-voltage units is equal to the number of the LED lamp strings,

wherein each of the constant-voltage units comprises an MOS transistor and a first operational amplifier, the MOS transistor has a drain connected to a cathode of a corresponding one of the LED lamp strings, a gate connected to an output terminal of the first operational amplifier and a source connected to the constant-current control circuit; the first operational amplifier has a positive input terminal connected to a reference voltage and an inverting input terminal connected to the source of the MOS transistor; the reference voltage is 1 volt (V); and the MOS transistor is an NMOS transistor.

Preferably, the constant-current control circuit is a balance chip.

Preferably, the LED backlight drive circuit further comprises a switch unit, an inductor and a rectification anti-backflow unit. One terminal of the inductor is used to receive an input voltage and the other terminal of the inductor is connected to anodes of the LED lamp strings via the rectification anti-backflow unit. The switch unit has a first terminal connected between the inductor and the rectification anti-backflow unit, a second terminal connected to the ground, and a control terminal for receiving a pulse width modulation (PWM) signal.

Preferably, the rectification anti-backflow unit is a diode which has an anode connected to the inductor and a cathode connected to the anodes of the LED lamp strings.

Preferably, the switch unit is an MOS transistor, which has a drain connected between the inductor and the rectification anti-backflow unit, a source connected to the ground, and a gate for receiving a PWM signal.

Preferably, the LED backlight drive circuit further comprises a minimum voltage detection circuit, a PWM control circuit for outputting the PWM signal and a second operational amplifier. An input terminal of the minimum voltage detection circuit is connected to cathodes of the LED lamp strings. The second operational amplifier has an inverting input terminal connected to an output terminal of the minimum voltage detection circuit, a positive input terminal connected to another reference voltage, and an output terminal connected to the PWM control circuit. The PWM control circuit is connected to the control terminal of the switch unit.

Preferably, the reference voltage connected to the positive input terminal of the second operational amplifier is 2.5 V.

According to the present disclosure, by additionally providing a constant-voltage unit between the LED lamp strings and the constant-current control circuit so that differences of the sums of turn-on voltage drops Vf of the respective LED lamp strings are applied to the constant-voltage unit, the voltages applied across the constant-current control circuit become identical. This can decrease the power loss and the temperature of the constant-current control circuit, thus improving stability of the LED backlight drive circuit.

### BRIEF DESCRIPTION OF THE DRAWINGS

FIG. 1 is a schematic circuit diagram of an LED backlight drive circuit in a prior art large-size liquid crystal panel; and

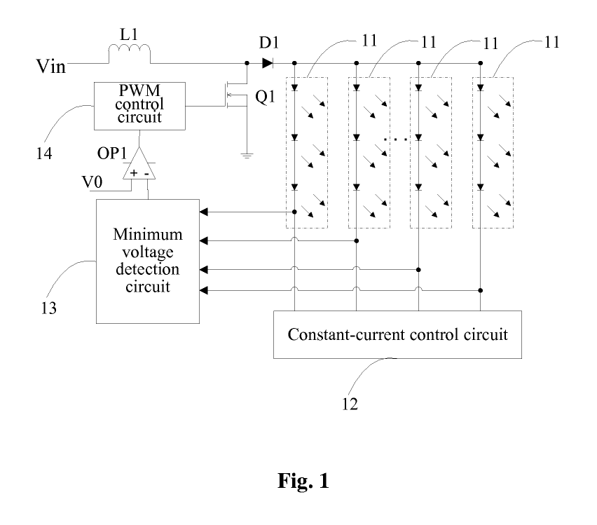

FIG. 2 is a schematic circuit diagram of a preferred embodiment of the LED backlight drive circuit according to the present disclosure.

Hereinafter, implementations, functional features and advantages of the present disclosure will be further described with reference to embodiments thereof and the attached drawings.

### DETAILED DESCRIPTION

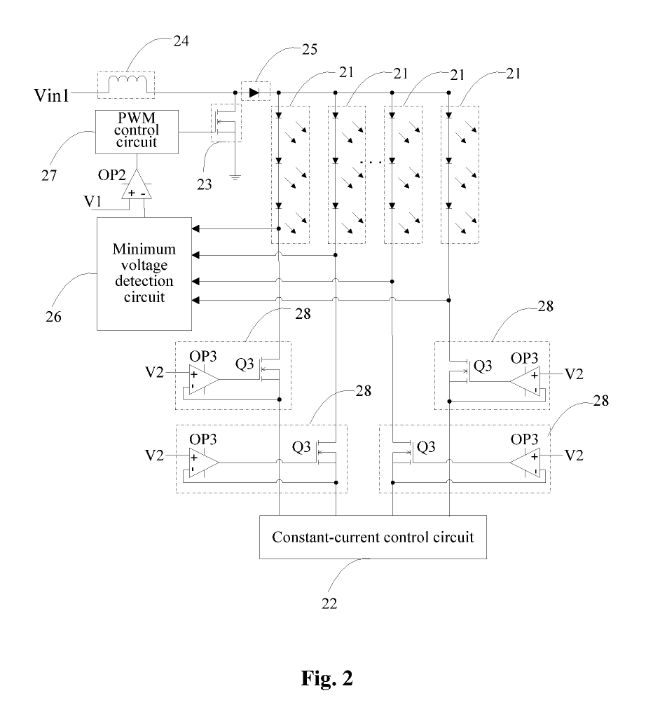

FIG. 2 illustrates a schematic circuit diagram of a preferred embodiment of an LED backlight drive circuit according to the present disclosure. As shown in FIG. 2, the LED backlight drive circuit comprises a voltage input terminal Vin 1, a plurality of LED lamp strings 21 connected in parallel, a constant-current control circuit 22, a switch unit 23, an inductor 24, a rectification anti-backflow unit 25, a minimum voltage detection circuit 26, a PWM control circuit 27, an operational amplifier OP2 and a plurality of constant-voltage units 28. The number of the constant-voltage units 28 is equal to the number of the LED lamp strings 21. The plurality of constant-voltage units 28 are connected between the plurality of LED lamp strings 21 and the constant-current control circuit 22 respectively. The constant-current control circuit 22 may be a balance chip (Balance IC) in this embodiment.

By additionally providing the constant-voltage unit 28 (a closed-cycle control system) between the LED lamp strings 21 and the constant-current control circuit 22, the aforesaid LED backlight drive circuit applies differences of the sums of turn-on voltage drops Vf of the respective LED lamp strings 21 to the constant-voltage unit 28 so that the voltages applied across the constant-current control circuit 22 become identical. This can decrease the power loss and the temperature of the constant-current control circuit 22, thus improving stability of the LED backlight drive circuit.

One terminal of the inductor 24 is used to receive an input voltage and the other terminal of the inductor 24 is connected to anodes of the LED lamp strings 21 via the rectification anti-backflow unit 25. The switch unit 23 has a first terminal (not labeled) connected between the inductor 24 and the rectification anti-backflow unit 25, a second terminal (not labeled) connected to the ground, and a control terminal (not labeled) connected to the PWM control circuit 27. The rectification anti-backflow unit 25 may be a diode which has an anode connected to the inductor 24 and a cathode connected to the anodes of the LED lamp strings 21. The switch unit 23 may be an NMOS transistor, of which a first terminal is a drain, a second terminal is a source and a control terminal is a gate. Through quick turning on/off of the switch unit 23, the inductor 24 can be charged or discharged to supply electric energy for the LED lamp strings 21. The inductor 24 is charged when the switch unit 23 is turned on and discharged when the switch unit 23 is turned off. The rectification anti-backflow unit 25 is used to prevent introduction of the voltage from the anodes of the LED lamp strings 21 back into the inductor when the switch unit 23 is turned on, and to rectify the discharging current of the inductor 24 for output when the switch unit 23 is turned off.

An input terminal (not labeled) of the minimum voltage detection circuit 26 is connected to cathodes of the LED lamp strings 21 to detect a minimum voltage of cathodes of the LED lamp strings 21, and to feed back the minimum voltage of cathodes of the LED lamp strings 21 to the PWM control circuit 27 via the operational amplifier OP2. The operational amplifier OP2 has a positive input terminal (not labeled) connected to a first reference voltage V1, an inverting input terminal (not labeled) connected to an output terminal (not labeled) of the minimum voltage detection circuit 26 to receive the minimum voltage of cathodes, and an output terminal (not labeled) connected to the PWM control circuit 27. The operational amplifier OP2 is configured to adjust an output voltage according to the minimum voltage of cathodes received at the inverting input terminal thereof. The first reference voltage V1 of the operational amplifier OP2 may be adjusted depending on specific requirements, but is generally 2.5 V.

The PWM control circuit 27 is connected to the MOS transistor 23. The PWM control circuit 27 is configured to adjust a duty ratio of a PWM signal according to the output voltage of the operational amplifier OP2 so that a turn-on time and a turn-off time of the MOS transistor 23 can be adjusted to adjust the anode voltage of the LED lamp strings 21. Specifically, if a voltage of the inverting input terminal is lower than the first reference voltage V1, the output voltage of the operational amplifier OP2 will increase; consequently, the duty ratio of the PWM signal outputted by the PWM control circuit 27 increases to result in an increased anode voltage of the LED lamp strings 21. Conversely, if the voltage of the inverting input terminal is higher than the first reference voltage V1, the output voltage of the operational amplifier OP2 will decrease; consequently, the duty ratio of the PWM signal outputted by the PWM control circuit 27 decreases to result in an decreased anode voltage of the LED lamp strings 21.

In this embodiment, the constant-current control circuit 22 is configured to control magnitudes of currents flowing through the LED lamp strings 21 to be the same. However, in other embodiments, the constant-current control circuit 22 may be further used to receive a PWM dimming signal, and through the PWM dimming signal, a duty ratio of currents flowing through the LED lamp strings 21 is adjusted to regulate luminance of the LED lamp strings 21.

Each of the constant-voltage units 28 comprises an MOS transistor Q3 and an operational amplifier OP3. The MOS transistor Q3 has a drain connected to a cathode of a corresponding one of the LED lamp strings 21, a gate connected to an output terminal of the operational amplifier OP3 and a source connected to the constant-current control circuit 22. The operational amplifier OP3 has a positive input terminal for receiving a second reference voltage V2 and an inverting input terminal connected to the source of the MOS transistor Q3. The magnitude of the second reference voltage V2 may be determined by a voltage needed to be applied to the constant-current control circuit 22, but is generally 1V. The MOS transistor Q3 is an NMOS transistor.

If drain voltages of MOS transistors Q3 are different from each other due to the differences of the sums of turn-on voltage drops Vf of the LED lamp strings 21, source voltages of the MOS transistors Q3 will also be different from each other. Then, because of the virtual short-circuit characteristics between the positive input terminal and the inverting input terminal of each of the operational amplifiers OP3, each of the operational amplifiers OP3 will adjust the source voltage of the respective MOS transistor Q3 to the voltage of the positive input terminal (i.e., the second reference voltage V2) quickly. Furthermore, by changing an output voltage, a turn-on impedance of each of the MOS transistors Q3 is adjusted to keep the source voltage of the MOS transistor Q3 stably at the second reference voltage V2, so as to make the voltages applied to the constant-current control circuit 22 identical in magnitude.

For example, if a source voltage of one of the MOS transistors Q3 is higher than that of other MOS transistors Q3, then an output voltage of the corresponding operational amplifier OP3 connected to the MOS transistor Q3 will become lower and, consequently, a turn-on impedance of the MOS transistor Q3 will become greater. As a result, the source voltage of the MOS transistor Q3 still remains the same as those of the other MOS transistors Q3, i.e., the source voltages of the MOS transistors Q3 will all be kept as the second reference voltage V2 stably.

By using an MOS transistor Q3 which can withstand a high voltage and the operational amplifiers OP3 in the aforesaid LED backlight drive circuit, a stable voltage is formed and applied to the constant-current control circuit 22. For example, if the constant-current control circuit 22 is a balance chip (Balance IC), the stable voltage may be applied at pins of the Balance IC. Thereby, the LED backlight drive circuit can keep voltages at pins of the Balance IC constant. This can decrease the power loss and the temperature of the balance chip, thus improving stability of the LED backlight drive circuit.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

1. A light emitting diode (LED) backlight drive circuit, comprising a plurality of LED lamp strings connected in parallel and a constant-current control circuit for controlling magnitudes of currents flowing through the LED lamp strings to be the same, wherein the LED backlight drive circuit further comprises:
a plurality of constant-voltage units connected between the plurality of LED lamp strings and the constant-current control circuit respectively, wherein the number of the constant-voltage units is equal to the number of the LED lamp strings,
wherein each of the constant-voltage units comprises a metal oxide semiconductor (MOS) transistor and a first operational amplifier, the MOS transistor has a drain connected to a cathode of a corresponding one of the LED lamp strings, a gate connected to an output terminal of the first operational amplifier and a source connected to the constant-current control circuit; and the first operational amplifier has a positive input terminal connected to a reference voltage and an inverting input terminal connected to the source of the MOS transistor.

2. The LED backlight drive circuit of claim 1, wherein the reference voltage is 1 volt (V).

3. The LED backlight drive circuit of claim 1, wherein the MOS transistor is an NMOS transistor.

4. The LED backlight drive circuit of claim 1, wherein the constant-current control circuit is a balance chip.

5. The LED backlight drive circuit of claim 1, further comprising a switch unit, an inductor and a rectification anti-backflow unit, wherein one terminal of the inductor is used to receive an input voltage and the other terminal of the inductor is connected to anodes of the LED lamp strings via the rectification anti-backflow unit, and the switch unit has a first terminal connected between the inductor and the rectification anti-backflow unit, a second terminal connected to the ground, and a control terminal for receiving a pulse width modulation (PWM) signal.

6. The LED backlight drive circuit of claim 5, wherein the rectification anti-backflow unit is a diode which has an anode connected to the inductor and a cathode connected to the anodes of the LED lamp strings.

7. The LED backlight drive circuit of claim 5, wherein the switch unit is an MOS transistor, which has a drain connected between the inductor and the rectification anti-backflow unit, a source connected to the ground, and a gate for receiving a PWM signal.

8. The LED backlight drive circuit of claim 5, further comprising a minimum voltage detection circuit, a PWM control circuit for outputting the PWM signal and a second operational amplifier, wherein an input terminal of the minimum voltage detection circuit is connected to cathodes of the LED lamp strings; the second operational amplifier has an inverting input terminal connected to an output terminal of the minimum voltage detection circuit, a positive input terminal connected to another reference voltage, and an output terminal connected to the PWM control circuit; and the PWM control circuit is connected to the control terminal of the switch unit.

9. The LED backlight drive circuit of claim 8, wherein the reference voltage connected to the positive input terminal of the second operational amplifier is 2.5 V.

10. An LED backlight drive circuit, comprising a plurality of LED lamp strings connected in parallel and a constant-current control circuit for controlling magnitudes of currents flowing through the LED lamp strings to be the same, wherein the LED backlight drive circuit further comprises:
a plurality of constant-voltage units connected between the plurality of LED lamp strings and the constant-current control circuit respectively, wherein the number of the constant-voltage units is equal to the number of the LED lamp strings,
wherein each of the constant-voltage units comprises an MOS transistor and a first operational amplifier, the MOS transistor has a drain connected to a cathode of a corresponding one of the LED lamp strings, a gate connected to an output terminal of the first operational amplifier and a source connected to the constant-current control circuit; the first operational amplifier has a positive input terminal connected to a reference voltage and an inverting input terminal connected to the source of the MOS transistor; the reference voltage is 1 volt (V); and the MOS transistor is an NMOS transistor.

11. The LED backlight drive circuit of claim 10, wherein the constant-current control circuit is a balance chip.

12. The LED backlight drive circuit of claim 10, further comprising a switch unit, an inductor and a rectification anti-backflow unit, wherein one terminal of the inductor is used to receive an input voltage and the other terminal of the inductor is connected to anodes of the LED lamp strings via the rectification anti-backflow unit, and the switch unit has a first terminal connected between the inductor and the rectification anti-backflow unit, a second terminal connected to the ground, and a control terminal for receiving a PWM signal.

13. The LED backlight drive circuit of claim 12, wherein the rectification anti-backflow unit is a diode which has an anode connected to the inductor and a cathode connected to the anodes of the LED lamp strings.

14. The LED backlight drive circuit of claim 12, wherein the switch unit is an MOS transistor, which has a drain connected between the inductor and the rectification anti-backflow unit, a source connected to the ground, and a gate for receiving a PWM signal.

15. The LED backlight drive circuit of claim 12, further comprising a minimum voltage detection circuit, a PWM control circuit for outputting the PWM signal and a second operational amplifier, wherein an input terminal of the minimum voltage detection circuit is connected to cathodes of the LED lamp strings; the second operational amplifier has an inverting input terminal connected to an output terminal of the minimum voltage detection circuit, a positive input terminal connected to another reference voltage, and an output terminal connected to the PWM control circuit; and the PWM control circuit is connected to the control terminal of the switch unit.

16. The LED backlight drive circuit of claim 15, wherein the reference voltage connected to the positive input terminal of the second operational amplifier is 2.5 V.

17. The LED backlight drive circuit of claim 2, wherein the constant-current control circuit is a balance chip.

18. The LED backlight drive circuit of claim 3, wherein the constant-current control circuit is a balance chip.

19. The LED backlight drive circuit of claim 2, further comprising a switch unit, an inductor and a rectification anti-backflow unit, wherein one terminal of the inductor is used to receive an input voltage and the other terminal of the inductor is connected to anodes of the LED lamp strings via the rectification anti-backflow unit, and the switch unit has a first terminal connected between the inductor and the rectification anti-backflow unit, a second terminal connected to the ground, and a control terminal for receiving a pulse width modulation (PWM) signal.

20. The LED backlight drive circuit of claim 3, further comprising a switch unit, an inductor and a rectification anti-backflow unit, wherein one terminal of the inductor is used to receive an input voltage and the other terminal of the inductor is connected to anodes of the LED lamp strings via the rectification anti-backflow unit, and the switch unit has a first terminal connected between the inductor and the rectification anti-backflow unit, a second terminal connected to the ground, and a control terminal for receiving a pulse width modulation (PWM) signal.
